(19) United States
(12) Patent Application Publication
(10) Pub. No.: US 2010/0317367 A1
(43) Pub. Date: Dec. 16, 2010

(54) In-vehicle device and system for communicating with base stations

(75) Inventor: Daisuke Tamura, Obu-city (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/802,289

(22) Filed: Jun. 3, 2010

(30) Foreign Application Priority Data
Jun. 12, 2009 (JP) 2009-141445

(51) Int. Cl. H04W 64/00

(52) U.S. Cl. 455/456.1

(57) ABSTRACT

An in-vehicle device for communicating with base stations includes: a radio wave detection element for detecting a radio wave from the stations; a position detection element for receiving information of position coordinates of the vehicle from an external device; a base station position obtaining element for obtaining position coordinates of each station based on data on the radio wave; a communication element for communicating with each station via the radio wave; and a controller for comparing the position coordinates of the vehicle and each station to determine whether the station is disposed in a predetermined distance range, for selecting one station in the predetermined range and providing a signal level equal to or larger than a predetermined signal level, and for controlling the communication element to communicate with the one station.

### CROSS REFERENCE TO RELATED APPLICATION

This application is based on Japanese Patent Application No. 2009-141445 filed on Jun. 12, 2009, the disclosure of which is incorporated herein by reference.

### FIELD OF THE INVENTION

The present invention relates to an in-vehicle device for communicating with multiple base stations via a radio wave, and an in-vehicle system for communicating with multiple base stations via a radio wave.

### BACKGROUND OF THE INVENTION

A cell phone receives a radio wave from multiple base stations, and selects one of the base stations, from which the cell phone receives a radio wave with the strongest receiving strength. Thus, the cell phone starts to communicate with the one of base stations. In this case, the cell phone rarely receives a radio wave from a base station, which is disposed at a place extremely far from the cell phone. For example, the base station may be disposed at a place such as a top of a mountain so that there is no blockage around the base station. In such a case, although a radio wave transmitted from the base station reaches the cell phone, a radio wave transmitted from the cell phone may not reach the base station. This phenomenon is defined as an over reach phenomenon. Thus, when the radio wave from the cell phone does not reach the base station as an opposite side of communication, the cell phone cannot communicate with the base station although an image on a screen of the cell phone shows that the cell phone is available. Here, the image on the screen is, for example, multiple antenna icons. When the number of antenna icons is large, the communication status of the cell phone is excellent.

JP-B2-2731708 corresponding to U.S. Pat. No. 5,521,368 teaches a technique in the base station for preventing the above over reach phenomenon. Specifically, when each base station receives an upload control channel signal, the base station always detects a signal receiving electric field level of the upload control channel signal. When the upload control channel signal is completely received, each base station compares the detected signal receiving electric field level as a detected level with an electric field threshold level. When the detected level is equal to or larger than the threshold level, it is determined that the received upload control channel signal is transmitted from a mobile terminal disposed in a service area of the base station. Thus, the received upload control channel signal is relayed to a mobile terminal exchange station. When the detected level is smaller than the threshold level, it is determined that the received upload control channel signal is transmitted from a mobile terminal disposed on an outside of the service area of the base station. This means that the over reach phenomenon occurs. Thus, the received upload control channel signal is eliminated.

Recently, a communication device for an ITS (i.e., intelligent transport system) is mounted on a vehicle. A mobile phone technology is applied to the communication device. This in-vehicle communication device as an in-vehicle device may be used at various places such as in a mountain area or a plain area. Accordingly, the in-vehicle device may communicate with other devices at a place where the over reach phenomenon occurs frequently, compared with an ordinary cell phone.

The in-vehicle device is suitably used for a part of an emergency call system. In view of this point, it is requested to improve the influence of the over reach phenomenon. The above technique for preventing the occurrence of the over reach phenomenon on the base station side disclosed in JP-B2-2731708 does not provide to handle the above difficulties sufficiently. It is necessary to apply the above technique to all of the base stations, i.e., to take actions to all of the base stations, when the above difficulties are handled by the above technique. Accordingly, it will costs huge to change, i.e., improve equipment in the base stations, which have been already built. Practically, it is difficult to realize the above technique.

### SUMMARY OF THE INVENTION

In view of the above-described problem, it is an object of the present disclosure to provide an in-vehicle device for communicating with multiple base stations via a radio wave. Further, it is another object of the present disclosure to provide an in-vehicle system for communicating with multiple base stations via a radio wave. In the in-vehicle device and system, an influence of an over reach phenomenon is improved, and therefore, reliability of communication is improved.

According to a first aspect of the present disclosure, an in-vehicle device mounted on a vehicle for communicating with a plurality of base stations includes: a radio wave detection element for detecting a radio wave from the base stations and for detecting a signal level of the radio wave, which provides predetermined data; a position detection element for receiving information of position coordinates of the vehicle from an external device; a base station position obtaining element for obtaining position coordinates of each base station according to the predetermined data on the radio wave; a communication element for communicating with each base station via the radio wave; and a controller for comparing the position coordinates of the vehicle with the position coordinates of each base station so that the controller determines whether the base station is disposed in a predetermined distance range from the vehicle, for selecting one of the base stations that is disposed in the predetermined range and provides the signal level of the radio wave equal to or larger than a predetermined signal level, and for controlling the communication element to communicate with the one of the base stations.

In the above device, the controller selects one of the base stations that is disposed in the predetermined range. Thus, the controller eliminates the base stations that are disposed on the outside of the predetermined range. Thus, the occurrence of over reach phenomenon is restricted at the device side. Further, the device communicates with the one of the base stations. Thus, even when the vehicle moves, the device can establish the communication with the one base station reliably. Thus, the communication status between the device and the one base station is improved. In the in-vehicle device, an influence of an over reach phenomenon is improved, and therefore, reliability of communication is improved.

According to a second aspect of the present disclosure, an in-vehicle device mounted on a vehicle for communicating with a plurality of base stations via a radio wave, which provides predetermined data, the in-vehicle device being switched from a sleep mode to an activation mode when communication with the base stations is necessitated, the in-vehicle device includes: a radio wave detection element for detecting a radio wave from the base stations and for detecting a signal level of the radio wave when the in-vehicle device is switched to the activation mode; a position detection element for receiving information of position coordinates of the vehicle from an external device when the in-vehicle device is switched to the activation mode; a base station position obtaining element for obtaining position coordinates of each base station according to the predetermined data on the radio wave; a communication element for communicating with each base station via the radio wave; and a controller for comparing the position coordinates of the vehicle with the position coordinates of each base station so that the controller determines whether the base station is disposed in a predetermined distance range from the vehicle, for selecting one of the base stations that is disposed in the predetermined range and provides the signal level of the radio wave equal to or larger than a predetermined signal level, and for controlling the communication element to communicate with the one of the base stations.

In the above device, the occurrence of over reach phenomenon is restricted at the device side. Further, the communication status between the device and the one base station is improved. In the in-vehicle device, an influence of an over reach phenomenon is improved, and therefore, reliability of communication is improved.

According to a third aspect of the present disclosure, an in-vehicle system mounted on a vehicle for communicating with a plurality of base stations includes: a wireless communication element for communicating with each base station via a radio wave, which provides data, and for detecting a signal level of the radio wave; a position detector for specifying position coordinates of the vehicle; and a controller for obtaining position coordinates of each base station according to the predetermined data on the radio wave, for comparing the position coordinates of the vehicle with the position coordinates of each base station so that the controller determines whether the base station is disposed in a predetermined distance range from the vehicle, for selecting one of the base stations that is disposed in the predetermined range and provides the signal level of the radio wave equal to or larger than a predetermined signal level, and for controlling the wireless communication element to communicate with the one of the base stations.

In the above system, the occurrence of over reach phenomenon is restricted at the device side. Further, the communication status between the device and the one base station is improved. In the in-vehicle system, an influence of an over reach phenomenon is improved, and therefore, reliability of communication is improved.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an in-vehicle device and a base station;

FIG. 2 is a flowchart showing a communication establishment process executed by the in-vehicle device; and

FIG. 3 is a diagram showing a process in each section when it is necessary to perform communication.

### DETAILED DESCRIPTION OF THE PREFERRED EMBODIMENTS

(Explanation of Structure of an In-Vehicle Device)

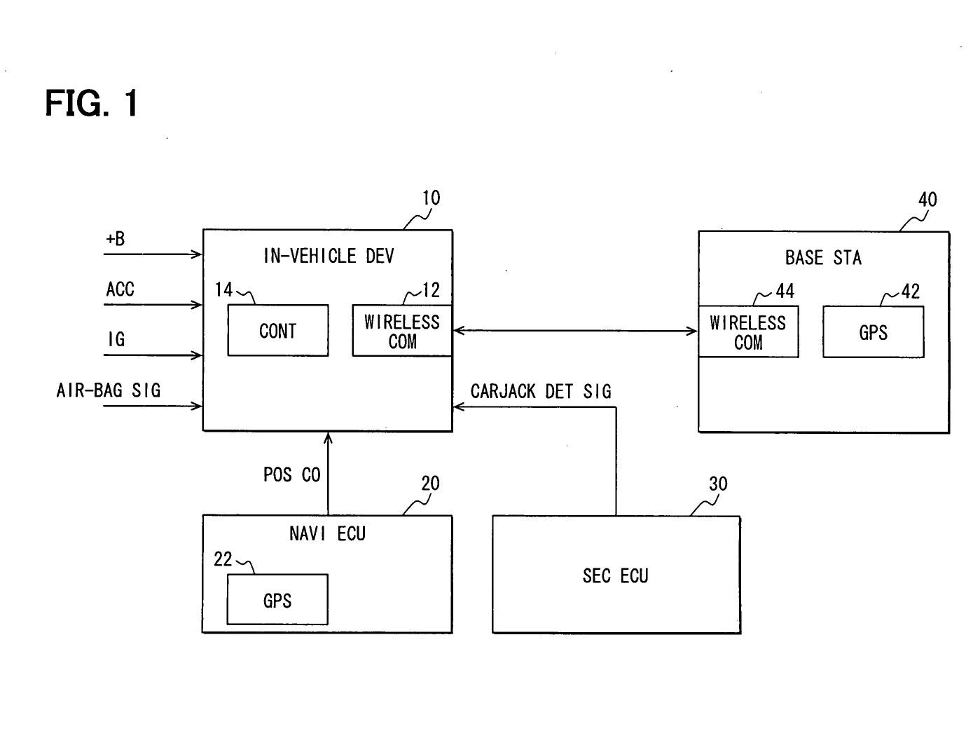

An in-vehicle device 10 is, for example, mounted on a vehicle. The device is shown in FIG. 1. Normally, the device 10 is in a sleep mode.

The device 10 includes a wireless communication element 12 form communicating with a base station 40 by a CDMA (code division multiple access) 2000 communication method and a controller 14 for executing various data processes. The device 10 detects a voltage when the device is coupled with an external device such as a navigation device. An output signal from an accessory switch that shows a turn-on state and a turn-off state of the accessory switch (ACC), an output signal from an ignition switch that shows a turn-on state and a turn-off state of the ignition switch (IG), and an output signal from an air bag device that shows inflation of the air bag device are input into the device 10. When the device 10 is energized, and the above output signals are input into the device 10 under a condition that the device 10 is in the sleep mode, the device 10 switches from the sleep mode to an activation mode. The device 10 is coupled with a navigation ECU 20 and a security ECU 30 so that the device 10 transmits data to and receives data from each ECU 20, 30. An in-vehicle battery energizes the device 10 so that the device 10 functions with using supplied electric power. In FIG. 1, +B represents the supplied electric power from the battery.

The controller 14 includes a CPU, a ROM, a RAM, a flash memory and the like. The controller 14 processes various data such that the CPU executes a control program stored in the ROM or the flash memory.

The navigation ECU 20 includes a GPS receiver 22 for executing position detection with a GPS (global positioning system). The navigation ECU 20 specifies position coordinates of the vehicle. The navigation ECU 20 outputs a signal showing the specified position coordinates to the device 10.

The security ECU 30 receives signals from a shock sensor, an inclination sensor and the like. When the security ECU 30 determines based on these signals that a carjacker hijacks the vehicle, the security ECU 30 outputs a carjacking detection signal to the device 10.

Accordingly, when the vehicle is stolen, and the in-vehicle device 10 receives the carjacking detection signal from the security ECU 30, the device 10 switches from the sleep mode to the activation mode.

The base station 40 includes a GPS receiver 42 for executing the position detection with the GPS so that the base station 40 synchronizes the time with other base stations. Further, the base station 40 has a function for specifying position coordinates of the base station 40 itself with using a position detection function with using the GPS. Further, the base station 40 includes a wireless communication element 44 so that the base station 40 communicates with the in-vehicle device 10 by the CDMA 2000 communication method.

When the in-vehicle device 10 wirelessly communicates with the base station 40 via the wireless communication elements 12, 44, the device 10 recognizes the position of the base station 40.

The base station 40 is disposed in a predetermined range such as 5 kilometers from the device 10. Accordingly, when the device 10 recognizes the base station 40 that communicates with the device 10, the device determines that the device 10 exists within a five-kilometer radius from the base station 40.

Here, in FIG. 1, one of the base stations 40 is shown.

(Explanation of Communication Establishment Process in the In-Vehicle Device)

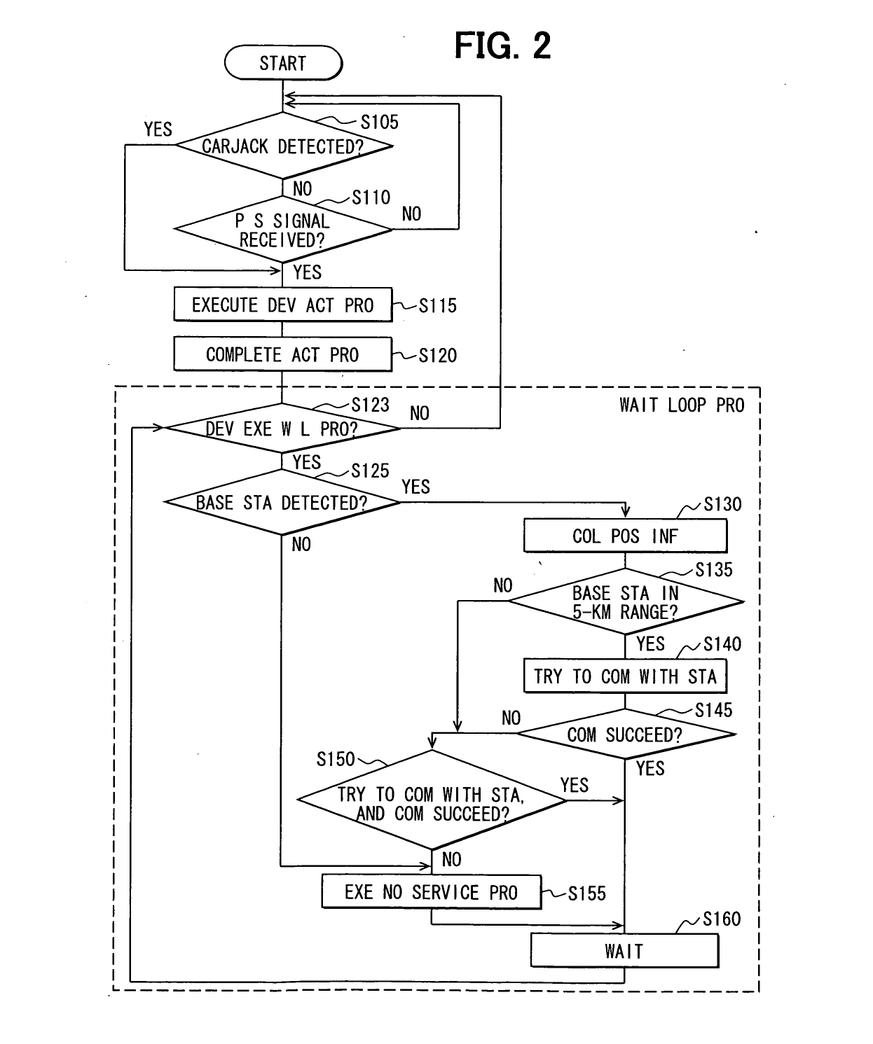

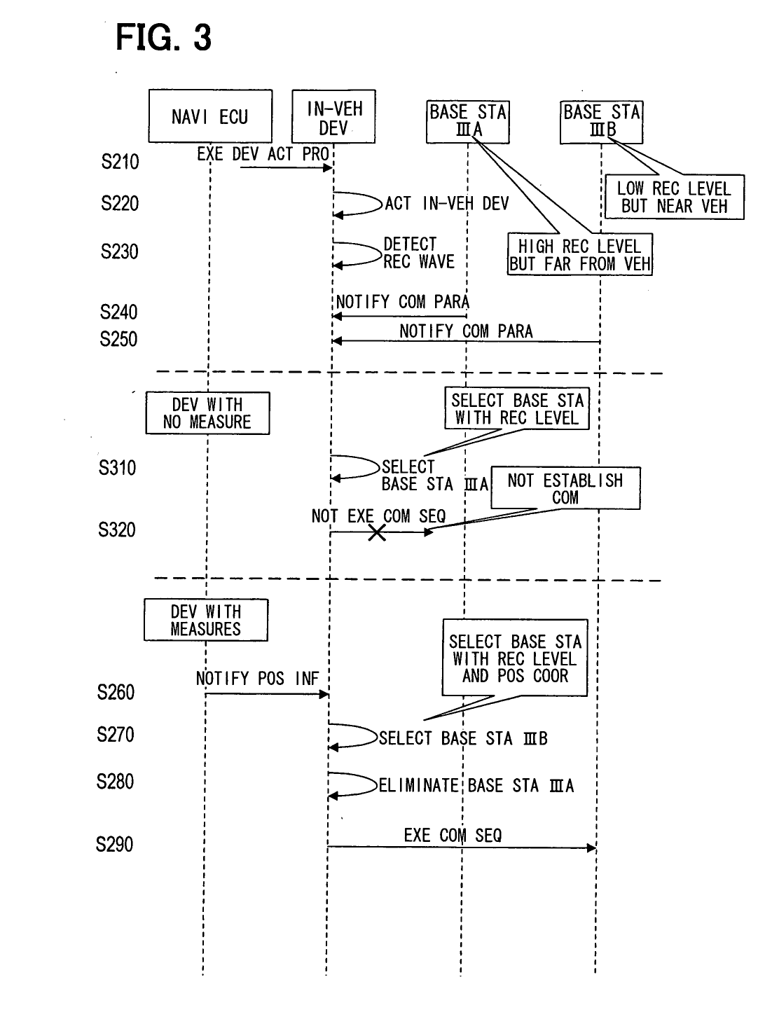

Next, a communication establishment process executed by the controller 14 in the device 10 will be explained with reference to FIGS. 2 and 3.

The communication establishment process is executed when the device 10 is in the sleep mode.

First, in step S105, the controller 14 determines whether the carjacking detection signal is received from the security ECU 30. When the device 10 does not receive the carjacking detection signal from the security ECU 30, i.e., when the determination in step S105 is “NO,” it proceeds to step S110. When the device 10 receives the carjacking detection signal from the security ECU 30, i.e., when the determination in step S105 is “YES,” it proceeds to step S115.

In step S110, the controller 14 determines whether the device 10 receives a power source signal. Here, the power source signal may be the output signal from the accessory switch that shows a turn-on state and a turn-off state of the accessory switch (ACC), the output signal from the ignition switch that shows a turn-on state and a turn-off state of the ignition switch (IG), and the output signal from the air bag device that shows inflation of the air bag device are input into the device 10. When the external device such as the navigation device is coupled with the device 10, and the device 10 detects the voltage from the external device, the controller determines that the power source signal is received. When one of these signals is received, the controller 14 determines that the device 10 receives the power source signal. Alternatively, when multiple signals are received, the controller may determine that the device 10 receives the power source signal. For example, when the ignition switch turns on, and further, the air bag is inflated, the controller may determine that the device 10 receives the power source signal. Alternatively, when the accessory switch turns on, and further, the ignition switch turns on, the controller may determine that the device 10 receives the power source signal. When the controller 14 determines that the device 10 does not receive the power source signal, i.e., when the determination in step S110 is “NO,” it returns to step S105. When the controller 14 determines that the device 10 receives the power source signal, i.e., when the determination in step S110 is “YES,” it goes to step S115. In this case, the device 10 determines that it is necessary to communicate with the base station 40.

In step S115, the controller 14 starts to execute a device activation process for activating the device 10. This step corresponds to step S210 in FIG. 3.

Then, in step S120, activation of the device 10 is completed in the device activation process. This step also corresponds to step S220 in FIG. 3. Then, it goes to a waiting loop process, which is provided by steps S125 to S160.

Here, when the device 10 switches from the activation mode to the sleep mode during execution of the waiting loop process, the controller 14 ends the waiting loop process, and then, it goes to step S105. Thus, in step S123, the controller 14 determines whether the device 10 executes the waiting loop process. When the controller 14 ends the waiting loop process, i.e., when the determination in step S123 is “NO,” it goes to step S105. When the controller 14 determines that the device 10 executes the waiting loop process, it proceeds to step S125.

In step. S125, the controller 14 determines whether base stations around the device 10 are detected. This step S125 corresponds to steps S230 to S250. When the controller 14 determines that base stations around the device 10 are detected, i.e., when the determination in step S125 is “YES” so that the base stations are detected, information about the detected base stations 40 are registered in a list stored in the RAM. Then, it goes to step S130. When the controller 14 determines that no base station around the device 10 is detected, i.e., when the determination in step S125 is “NO” so that the base station is not detected, it goes to step S155.

In step S130, information about a position of each base station, which is detected in step S125, is collected, i.e., the information of position coordinates of the base station is obtained.

In step S135, the controller 14 compares the position coordinates of the base station around the device 10 with position coordinates of the vehicle, which is obtained from the navigation ECU 20, so that the controller 14 determines whether the base station 40 is disposed within a predetermined distance from the vehicle. Here, the position coordinates of the vehicle are obtained in step S260 in FIG. 3. In this example embodiment, the predetermined distance is set to be five kilometers. When the base station 40 is disposed in the 5-kilometer range, i.e., when the determination in step S135 is “YES” so that the base station 40 is disposed within five kilometers, it goes to step S140. When the base station 40 is not disposed in the 5-kilometer range, i.e., when the determination in step S135 is “NO” so that the base station 40 is not disposed within five kilometers, it goes to step S150.

In step S140, the device 10 selects one of the bas stations disposed in the predetermined range, the one which provides excellent reception sensitivity. Further, the device 10 tries to communicate with the one of the base stations. This step corresponds to step S270 in FIG. 3. At this time, the device 10 tries to communicate with the base stations in descending order of a reception level of the radio wave, which is detected by the device 10.

In step S145, the controller 14 determines whether communication with the selected base station 40 succeeds. When the communication fails, i.e., when the determination in step S145 is “NO,” it goes to step S150. When the communication succeeds, i.e., when the determination in step S145 is “YES,” it goes to step S160.

In step S150, the controller 14 selects one of the base stations 40 disposed on the outside of the predetermined range, the one which provides excellent reception sensitivity. Then, the device 10 tries to communicate with the one of the base stations. When the communication fails, i.e., when the determination in step S150 is “NO,” it goes to step S155. When the communication succeeds, i.e., when the determination in step S150 is “YES,” it goes to step S160.

In step S155, no service process is executed. Specifically, the device 10 notifies that the vehicle is disposed on the outside of the service area of the base stations 40. Then, it goes to step S160.

In step S160, the controller 14 performs a standby process so that the controller 14 stands by for a predetermined time interval. Thus, after a predetermined waiting time interval has elapsed, it returns to step S125. At this time, as shown in step S280 in FIG. 3, the base stations 40 other than the one of the stations 40 that successfully communicates with the device 10 are eliminated from the list. Further, as shown in step S290 in FIG. 3, the device starts to transmit data to and receives data from the one of the base stations 40 that provides communication success. Then, it returns to step S125.

FIG. 3 shows the communication establishment process when it is necessary to execute communication with the base station 40 under a condition that the accessory switch and the ignition switch turn on. In FIG. 3, the navigation ECU functions as a position coordinate detection device, and the in-vehicle device functions as a communication device. The base station IIIA is disposed far from the vehicle, but the reception signal level of the in-vehicle device 10 is excellent. The base station IIIB is disposed near the vehicle, but the reception signal level of the device 10 is low.

In step S210, the in-vehicle device 10 starts to execute the device activation process. In step S220, the in-vehicle device as the communication device is activated. Then, in step S230, the reception radio wave is detected. In steps S240 and S250, the base station IIIA and the base station IIIB transmit, i.e., notify the communication parameters, respectively. Thus, the device 10 recognizes that the base station IIIA is disposed far from the vehicle although the reception signal level of the in-vehicle device 10 from the base station IIIA is excellent. Further, the device 10 recognizes that the base station IIIB is disposed near the vehicle although the reception signal level of the in-vehicle device 10 from the base station IIIB is low.

If no measure is implemented in the device 10, steps S310 and S320 are performed. Specifically, in step S310, one of the base stations 40 is selected based on the reception signal level. Thus, the bas station IIIA is selected. Then, in step S320, the radio wave from the device 10 is not transmitted to the base station IIIA, so that communication is not established between the device 10 and the station IIIA. Accordingly, communication sequence cannot be executed.

However, in the present example embodiment, certain measures are implemented in the device 10. Thus, in step S260, the position information of the vehicle is notified from the navigation ECU to the device 10. Thus, the device 10 recognizes the position coordinates of the vehicle. Thus, the device 10 compares the position coordinates of the base stations IIIA, IIIB and the position coordinates of the vehicle, i.e., the device 10, and then, the device 10 selects one of the base stations IIIA, IIIB in step S270 according to the intensity of the reception signal level and the comparison result of the position coordinates of the base stations IIIA, IIIB. Then, in step S280, the information about the base station IIIA is eliminated from the list. In step S290, the device 10 starts to execute the communication sequence with the base station IIIB.

The above in-vehicle device 10 selects the base stations 40 disposed in the predetermined range among the stations 40, which transmit the radio wave to the device 10. Thus, the device 10 eliminates the stations 40 disposed on the outside of the predetermined range. Thus, the occurrence of the over reach phenomenon is protected at the in-vehicle device side. Further, the device 10 selects the base stations 40, which provide the reception signal level of the detected radio wave equal to or larger than a predetermined signal level. Thus, the selected stations 40 are disposed in the predetermined range and provide the signal level equal to or larger than the predetermined level. Furthermore, the device 10 tries to communicate with the selected base stations 40 in descending order of the signal level of the base station 40. Thus, even when the vehicle moves, the device 10 can establish the communication with the selected base station 40 reliably. Thus, the communication status between the device 10 and the selected base stations 40 is improved. Accordingly, the occurrence of the over reach phenomenon is prevented. Thus, the device 10 establishes communication with the base station 40, which provide better communication status.

When the occurrence of the over reach phenomenon is restricted, the emergency call such as a carjack emergency call is surely performed.

Thus, the influence of the over reach phenomenon with respect to the device 10 is reduced, and the reliability of communication with the base station 40 is improved.

The above disclosure has the following aspects.

According to a first aspect of the present disclosure, an in-vehicle device mounted on a vehicle for communicating with a plurality of base stations includes: a radio wave detection element for detecting a radio wave from the base stations and for detecting a signal level of the radio wave, which provides predetermined data; a position detection element for receiving information of position coordinates of the vehicle from an external device; a base station position obtaining element for obtaining position coordinates of each base station according to the predetermined data on the radio wave; a communication element for communicating with each base, station via the radio wave; and a controller for comparing the position coordinates of the vehicle with the position coordinates of each base station so that the controller determines whether the base station is disposed in a predetermined distance range from the vehicle, for selecting one of the base stations that is disposed in the predetermined range and provides the signal level of the radio wave equal to or larger than a predetermined signal level, and for controlling the communication element to communicate with the one of the base stations.

In the above device, the controller selects one of the base stations that is disposed in the predetermined range. Thus, the controller eliminates the base stations that are disposed on the outside of the predetermined range. Thus, the occurrence of over reach phenomenon is restricted at the device side. Further, the device communicates with the one of the base stations. Thus, even when the vehicle moves, the device can establish the communication with the one base station reliably. Thus, the communication status between the device and the one base station is improved. In the in-vehicle device, an influence of an over reach phenomenon is improved, and therefore, reliability of communication is improved.

Alternatively, the controller may select a part of the base stations that are disposed in the predetermined range and provide the signal level of the radio wave equal to or larger than the predetermined signal level, and the controller may control the communication element to try to communicate with the part of the base stations respectively in descending order of the signal level. Further, the controller may determine the one of the base stations among the part of the base stations in such a manner that the one of the base stations provides highest reception sensitivity.

According to a second aspect of the present disclosure, an in-vehicle device mounted on a vehicle for communicating with a plurality of base stations via a radio wave, which provides predetermined data, the in-vehicle device being switched from a sleep mode to an activation mode when communication with the base stations is necessitated, the in-vehicle device includes: a radio wave detection element for detecting a radio wave from the base stations and for detecting a signal level of the radio wave when the in-vehicle device is switched to the activation mode; a position detection element for receiving information of position coordinates of the vehicle from an external device when the in-vehicle device is switched to the activation mode; a base station position obtaining element for obtaining position coordinates of each base station according to the predetermined data on the radio wave; a communication element for communicating with each base station via the radio wave; and a controller for comparing the position coordinates of the vehicle with the position coordinates of each base station so that the controller determines whether the base station is disposed in a predetermined distance range from the vehicle, for selecting one of the base stations that is disposed in the predetermined range and provides the signal level of the radio wave equal to or larger than a predetermined signal level, and for controlling the communication element to communicate with the one of the base stations.

In the above device, the occurrence of over reach phenomenon is restricted at the device side. Further, the communication status between the device and the one base station is improved. In the in-vehicle device, an influence of an overreach phenomenon is improved, and therefore, reliability of communication is improved.

Alternatively, the controller may select a part of the base stations that are disposed in the predetermined range and provide the signal level of the radio wave equal to or larger than the predetermined signal level, and the controller may control the communication element to try to communicate with the part of the base stations respectively in descending order of the signal level. Further, the controller may determine the one of the base stations among the part of the base stations in such a manner that the one of the base stations provides highest reception sensitivity. Further, the controller may determine that the communication with the base stations is necessitated when the controller receives at least one of an air-bag inflation signal, an ignition switch turn-on signal, an accessory switch turn-on signal, and a carjack detection signal.

According to a third aspect of the present disclosure, an in-vehicle system mounted on a vehicle for communicating with a plurality of base stations includes: a wireless communication element for communicating with each base station via a radio wave, which provides data, and for detecting a signal level of the radio wave; a position detector for specifying position coordinates of the vehicle; and a controller for obtaining position coordinates of each base station according to the predetermined data on the radio wave, for comparing the position coordinates of the vehicle with the position coordinates of each base station so that the controller determines whether the base station is disposed in a predetermined distance range from the vehicle, for selecting one of the base stations that is disposed in the predetermined range and provides the signal level of the radio wave equal to or larger than a predetermined signal level, and for controlling the wireless communication element to communicate with the one of the base stations.

In the above system, the occurrence of over reach phenomenon is restricted at the device side. Further, the communication status between the device and the one base station is improved. In the in-vehicle system, an influence of an over reach phenomenon is improved, and therefore, reliability of communication is improved.

Alternatively, the controller may select a part of the base stations that are disposed in the predetermined range and provide the signal level of the radio wave equal to or larger than the predetermined signal level. The controller may control the communication element to try to communicate with the part of the base stations respectively in descending order of the signal level, and the controller may determine the one of the base stations among the part of the base stations in such a manner that the one of the base stations provides highest reception sensitivity. Further, the in-vehicle system may be switched from a sleep mode to an activation mode when communication with the base stations is necessitated. The wireless communication element may communicate with each base station via the radio wave when the in-vehicle system is switched to the activation mode, and the position detector may specify the position coordinates of the vehicle when the in-vehicle device is switched to the activation mode. Furthermore, the controller may determine that the communication with the base stations is necessitated when the controller receives at least one of an air-bag inflation signal, an ignition switch turn-on signal, an accessory switch turn-on signal, and a carjack detection signal.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. An in-vehicle device mounted on a vehicle for communicating with a plurality of base stations comprising:
a radio wave detection element for detecting a radio wave from the base stations and for detecting a signal level of the radio wave, which provides predetermined data;
a position detection element for receiving information of position coordinates of the vehicle from an external device;
a base station position obtaining element for obtaining position coordinates of each base station according to the predetermined data on the radio wave;
a communication element for communicating with each base station via the radio wave; and
a controller for comparing the position coordinates of the vehicle with the position coordinates of each base station so that the controller determines whether the base station is disposed in a predetermined distance range from the vehicle, for selecting one of the base stations that is disposed in the predetermined range and provides the signal level of the radio wave equal to or larger than a predetermined signal level, and for controlling the communication element to communicate with the one of the base stations.

2. The in-vehicle device according to claim 1,
wherein the controller selects a part of the base stations that are disposed in the predetermined range and provide the signal level of the radio wave equal to or larger than the predetermined signal level, and
wherein the controller controls the communication element to try to communicate with the part of the base stations respectively in descending order of the signal level.

3. The in-vehicle device according to claim 2,
wherein the controller determines the one of the base stations among the part of the base stations in such a manner that the one of the base stations provides highest reception sensitivity.

4. An in-vehicle device mounted on a vehicle for communicating with a plurality of base stations via a radio wave, which provides predetermined data, the in-vehicle device being switched from a sleep mode to an activation mode when communication with the base stations is necessitated, the in-vehicle device comprising:
a radio wave detection element for detecting a radio wave from the base stations and for detecting a signal level of the radio wave when the in-vehicle device is switched to the activation mode;
a position detection element for receiving information of position coordinates of the vehicle from an external device when the in-vehicle device is switched to the activation mode;
a base station position obtaining element for obtaining position coordinates of each base station according to the predetermined data on the radio wave;
a communication element for communicating with each base station via the radio wave; and
a controller for comparing the position coordinates of the vehicle with the position coordinates of each base station so that the controller determines whether the base station is disposed in a predetermined distance range from the vehicle, for selecting one of the base stations that is disposed in the predetermined range and provides the signal level of the radio wave equal to or larger than a predetermined signal level, and for controlling the communication element to communicate with the one of the base stations.

5. The in-vehicle device according to claim 4,
wherein the controller selects a part of the base stations that are disposed in the predetermined range and provide the signal level of the radio wave equal to or larger than the predetermined signal level, and
wherein the controller controls the communication element to try to communicate with the part of the base stations respectively in descending order of the signal level.

6. The in-vehicle device according to claim 5,
wherein the controller determines the one of the base stations among the part of the base stations in such a manner that the one of the base stations provides highest reception sensitivity.

7. The in-vehicle device according to claim 4,
wherein the controller determines that the communication with the base stations is necessitated when the controller receives at least one of an air-bag inflation signal, an ignition switch turn-on signal, an accessory switch turn-on signal, and a carjack detection signal.

8. An in-vehicle system mounted on a vehicle for communicating with a plurality of base stations comprising:
a wireless communication element for communicating with each base station via a radio wave, which provides data, and for detecting a signal level of the radio wave;
a position detector for specifying position coordinates of the vehicle; and
a controller for obtaining position coordinates of each base station according to the predetermined data on the radio wave, for comparing the position coordinates of the vehicle with the position coordinates of each base station so that the controller determines whether the base station is disposed in a predetermined distance range from the vehicle, for selecting one of the base stations that is disposed in the predetermined range and provides the signal level of the radio wave equal to or larger than a predetermined signal level, and for controlling the wireless communication element to communicate with the one of the base stations.

9. The in-vehicle system according to claim 8,
wherein the controller selects a part of the base stations that are disposed in the predetermined range and provide the signal level of the radio wave equal to or larger than the predetermined signal level,
wherein the controller controls the communication element to try to communicate with the part of the base stations respectively in descending order of the signal level, and
wherein the controller determines the one of the base stations among the part of the base stations in such a manner that the one of the base stations provides highest reception sensitivity.

10. The in-vehicle system according to claim 9,
wherein the in-vehicle system is switched from a sleep mode to an activation mode when communication with the base stations is necessitated,
wherein the wireless communication element communicates with each base station via the radio wave when the in-vehicle system is switched to the activation mode, and
wherein the position detector specifies the position coordinates of the vehicle when the in-vehicle device is switched to the activation mode.

11. The in-vehicle device according to claim 10,
wherein the controller determines that the communication with the base stations is necessitated when the controller receives at least one of an air-bag inflation signal, an ignition switch turn-on signal, an accessory switch turn-on signal, and a carjack detection signal.
